(19) United States
(12) Patent Application Publication
(10) Pub. No.: US 2024/0356935 A1
(43) Pub. Date: Oct. 24, 2024

(54) EVENT-BASED THREAT DETECTION WITH WEAK LEARNER MODELS DATA SIGNAL AGGREGATION

(71) Applicant: Cisco Technology, Inc., San Jose, CA (US)

(72) Inventors: Michael Adam Polak, Praha (CZ); Veronika Andrea Polakova, Glasgow (GB); Lukas Batrla, Praha (CZ)

(21) Appl. No.: 18/237,282

(22) Filed: Aug. 23, 2023

Related U.S. Application Data
(60) Provisional application No. 63/461,396, filed on Apr. 24, 2023.

(51) Int. Cl. H04L 9/40

(52) U.S. Cl. CPC H04L 63/1416

(57) ABSTRACT

Techniques for identifying malicious threats for investigation using network telemetry data. The techniques include the use weak learner models to analyze data from multiple event sources. The techniques further include aggregating data signals from the weak learner models to generate a high-fidelity data signal of threat sources. The aggregated data signal can be sent to a Security Operation Center to provide a list of nodes with a high likelihood of malicious threats along with convicting evidence to aid in investigating the identified nodes.

### RELATED APPLICATIONS

This application claims priority to U.S. Provisional Application No. 63/461,396, filed on Apr. 24, 2023, which is incorporated herein by reference in its entirety and for all purposes.

### TECHNICAL FIELD

The present disclosure relates generally to techniques for identifying malicious actors and other entities across datasets of different origin. The techniques may be used to, among other things, identify likely candidates for investigation by a Security Operations Center (SOC) team.

### BACKGROUND

The network and client infrastructure that is used for operating command-and-control (C&C) attacks and other high-impact cyber threats are known to be short-lived because malicious actors are forced to vary these entities quickly when found and published by the cyber community or security industry. The entities are described by the indicators of compromise (IoC's) such as domains (e.g., fully qualified domain names), internet protocol (IP) addresses, uniform resource locator (URL) addresses, or hashes of binaries. Maintaining a reliable list of malicious network entities in their active phase is critical for the efficacy of any intrusion detection system. Since each candidate entity must be human reviewed prior to adding a specific candidate entity to the list of malicious network entities, only a very limited number of candidate entities can be processed.

In the domain of cybersecurity, extended detection and response systems (XDR) process security events collected from multiple sources originating from different telemetries, cybersecurity products, vendors, etc. Consequently, the increasing number of security events renders it unfeasible for a Security Operations Center (SOC) team to process and validate all of them. Moreover, the severity of the events might not be known precisely in all cases since different vendors of the integrated security products have different methods of assigning its value. With many examples of security events describing a common benign behavior, such as software updates or status logs, instead of representing a strong signal indicating the presence of malware, this introduces even more manual work for the SOC team as they need to find the relevant security events manually. In addition, the SOC team needs to find all pieces of evidence for a specific threat so that they know the infection vector and the whole execution chain of the malware that was executed on the device so that they can react to it and remediate the threat.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture that may be used to implement various aspects of the threat detection techniques described herein.

FIG. 2A illustrates an example bipartite graph that may be used as an input for some of the various threat detection techniques and algorithms described herein.

FIG. 2B illustrates the example bipartite graph in which multiple malicious edges have been identified for determining a maliciousness score associated with a modality.

FIG. 2C illustrates an example subgraph of the bipartite graph that indicates respective modalities connecting a candidate malicious entity to a known, malicious entity.

FIG. 3 is a flow diagram illustrating an example method associated with the threat detection techniques described herein.

FIG. 4 is a schematic illustration of a computer network architecture employing weak learner models and link aggregation to efficiently identify nodes for malicious threat investigation.

FIG. 5 is a bar graph illustrating the cardinality of events generated by individual sources.

FIG. 6 is a bar graph illustrating combined cardinality of events for multiple time windows.

FIG. 7 is a graph illustrating grouped threat events organized by time and pivot keys.

FIG. 8 is a bar graph illustrating combined cardinalities of events in each individual time window.

FIG. 9 is a graph illustrating time and key separated events with specific examples of possible, real-world event types.

FIG. 10 is a flow chart illustrating a method for applying a weak-learner and aggregation model to identify nodes for threat investigation.

FIG. 11 is schematic illustrating an Adaptive Risk Map Graph starting from a single malicious seed node.

FIG. 12 is a schematic illustrating the Adaptive Risk Map Graph applying risk weight factors to nodes based on their relationship with the malicious seed node.

FIG. 13 is a schematic of the Adaptive Risk Map Graph (A-RMG) after investigating and identifying additional malicious seed nodes and safe nodes.

FIG. 14 is a graph illustrating a process for iteratively identifying candidate nodes for threat investigation by a Security Operations Center (SOC).

FIG. 15 is a schematic illustrating the use of an Adaptive Risk Map Graph (A-RMG) to identify nodes for threat investigation starting from two known malicious seed nodes.

FIG. 16 is a schematic illustrating the use of the A-RMG after identifying a malicious threat seed node and a safe node.

FIG. 17 is a flowchart illustrating a method for efficiently identifying candidate nodes for threat investigation using an Adaptive Risk Map Graph (A-RMG) technique.

FIG. 18 is a computing system diagram illustrating an example configuration of a data center that can be utilized to implement aspects of the technologies disclosed herein.

FIG. 19 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for providing event-based threat detection in a computer network. A method as described herein includes receiving telemetry data for a computer network. The telemetry data includes a plurality of events. The method further includes analyzing a plurality of events using a plurality of weak learner models each of which is configured to analyze a particular aspect of an event to generate a plurality off weak learner data signals. The method further includes aggregating the weak learner data signals to select one or more nodes for further investigation. The one or more nodes selected for further investigation can be investigated by an investigation service such as a Security Operations Center (SOC). Additionally, the techniques described herein may be performed as a method and/or by a system n having non-transitory computer-readable media storing computer-executable instructions that, when executed by one or more processors, performs the techniques described above.

### Example Embodiments

This disclosure describes techniques for identifying malicious actors and other entities across datasets of different origin. The techniques may be used to, among other things, convict malicious network traffic and identify command-and-control infrastructure of newly detected malware even if no direct communication between two different entities such as binaries and domains, is observed. The disclosed techniques provide for a scalable IoC retrieval algorithm that has a low computational cost and provides a very accurate retrieval of high-risk malicious entities. On top of that, the retrieved entities may be supported with an understandable explanation of why they were selected. This explanation can increase throughput during a confirmation phase since it provides valuable additional evidence supporting the decision.

In some examples, the techniques described herein may leverage interaction of a main entity (e.g., domain) with other modalities (e.g., IP addresses, user nodes, client devices, servers, etc.) extracted from telemetry data associated with an intrusion detection system (IDS) or intrusion prevention system (IPS). In some examples, a bipartite graph may be composed for each modality, and the bipartite graph may be formed by main entities (e.g., domain nodes), entities of a given modality (e.g., server IP addresses, user nodes, etc.) and edges reflecting the fact that the connected nodes occurred in one log event (e.g., a user visited a domain, a modality interacted with an entity, etc.). Based at least in part on a given bipartite graph, any modalities interacting with known malicious entities may be identified and a maliciousness score may be calculated or otherwise determined for the modality. The maliciousness scores of all modalities interacting with a candidate entity may then be aggregated to determine a maliciousness vector for the candidate entity, where each dimension of the vector corresponds to the candidate entity maliciousness based on a given modality. The final maliciousness score for an entity may then be calculated or otherwise determined based on another aggregation over the maliciousness vector. In some examples, all of the candidate entities of the bipartite graph may be sorted by their final maliciousness score, and a selection of the highest at-risk entities may be selected for a confirmation stage. Additionally, or alternatively, in some examples an explanation of the maliciousness score and how it was determined for each candidate entity may be given by a decision-relevant subgraph.

By way of example, and not limitation, a method according to the techniques described herein may include receiving input data indicative of network interactions between entities and modalities. In some examples, the input data may be transformed into a bipartite graph that is determined based at least in part on telemetry data associated with an intrusion detection system. The bipartite graph may describe or otherwise be indicative of interactions between one or more entities (e.g., domains) and one or more modalities (e.g., users or IPs). For example, the bipartite graph may include a first set of vertices representing the entities (including both candidate entities and known, malicious entities), a second set of vertices representing the modalities, and multiple edges connecting individual vertices of the first set of vertices with respective vertices of the second set of vertices. In some instances, the multiple edges may represent current or prior interactions between the entities and the modalities.

In some examples, the method may include determining a maliciousness score for each of the candidate entities based at least in part on the input data. In some examples, a value of a maliciousness score for a specific candidate entity may be based at least in part on a number of the modalities that are interacting with the specific candidate entity, and which are also interacting with one or more known, malicious entities. For example, in some instances respective maliciousness scores associated with each one of the modalities may be determined. In some examples, for each of the respective modalities, a value of their respective maliciousness score may be equal to a number of known, malicious entities that the respective modality is interacting with divided by a total number of the entities that the respective modality is interacting with. By way of example, and not limitation, if a first modality is interacting with a total of four entities, and one of the four entities is a known, malicious entity, then the value of the maliciousness score for that first modality may be equal to ¼ (or 0.25). Additionally, in some examples, the maliciousness score associated with the specific candidate entity may be determined based at least in part on an aggregation of the respective maliciousness scores associated with each one of the modalities that are interacting with the specific candidate entity. Continuing the above example, if the specific candidate entity is interacting with the first modality (maliciousness score value of ¼ (or 0.25) and with a second modality that has a maliciousness score value of ½ (or 0.5), then the maliciousness score value for the specific candidate entity may be equal to the average of ¼ and ½ (which is equal to ⅜ (or 0.375).

In some examples, the method may include determining whether the value of the maliciousness score for the specific candidate entity exceeds a threshold value. In some instances, the threshold value may be a specific value set by a threat analyst, such as 0.3, 0.4, 0.6, etc. In some examples a maliciousness rank of the specific candidate entity relative to other candidate entities may be determined based at least in part on the value of the maliciousness score, and whether the value of the maliciousness score exceeds the threshold value may be based at least in part on the maliciousness rank of the specific candidate entity. For instance, if the specific candidate entity is within a top ten of candidate entities with a highest maliciousness ranking, then the threshold value may be determined as the maliciousness score value corresponding to the tenth ranked entity.

In some examples, if the value of the maliciousness score exceeds the threshold value, a report associated with the first entity may be generated. In some examples, the report may be sent to a threat analyst associated with a network who validates the actual maliciousness of the candidate entities. In some examples, the report may include the value of the maliciousness score associated with the specific candidate entity and a request to identify (e.g., classify, label, categorize, etc.) the specific candidate entity as a new malicious entity. Additionally, or alternatively, the report may include an indication of the one or more malicious entities that the modalities have interacted with in addition to the specific candidate entity. Additionally, or alternatively, the report further may include a maliciousness vector associated with the specific candidate entity, the maliciousness vector including respective maliciousness scores associated with each one of the modalities that are interacting with the specific candidate entity. In addition, or in the alternative, to the examples above, the report may also include one or more of: (i) a maliciousness score (e.g., reputation) for each modality (e.g., IPs, files, users, etc.) interacting with the specific candidate entity: (ii) an aggregated score over the maliciousness vector (i.e., over different data sources) for each entity (e.g., domain): (iii) an ordering of both entities and modalities by their maliciousness score; and/or (iv) supporting information providing the reasoning for the maliciousness score, which may contain a subgraph of the bipartite graph indicating the neighbors for each entity or modality node and/or full information for the maliciousness score computation for a given candidate entity.

The techniques described herein provide for several improvements in computer-related technology in the field of threat detections and malware identification. For instance, the disclosed techniques provide for a scalable IoC retrieval algorithm that has a low computational cost. Additionally, the techniques provide a very accurate retrieval of high-risk malicious entities. On top of that, the retrieved entities may be supported with an understandable explanation of why they were selected. This explanation can increase throughput during a confirmation phase (which may be either manual or automated) since it provides valuable additional evidence supporting the decision. Other improvements will be readily apparent to those having ordinary skill in the art.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

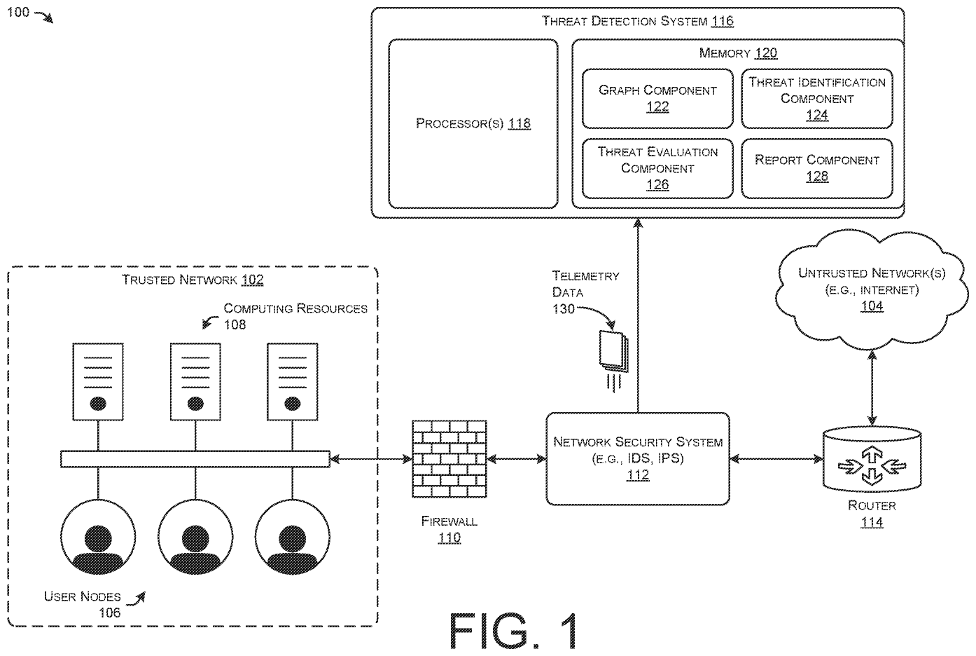

FIG. 1 illustrates an example architecture 100 that may be used to implement various aspects of the threat detection techniques described herein. The architecture 100 may include, in some examples, a trusted network 102 that has access to one or more untrusted network(s) 104, such as the internet. For instance, one or more user nodes 106 and/or computing resources 108 of the trusted network 102 may be accessing entities (e.g., domains) over the one or more untrusted network(s) 104. As an example, a user associated with one of the user nodes 106 may be visiting a webpage on the internet, which is outside of the trusted network 102.

In some examples, when traffic is sent between the trusted network 102 and the one or more untrusted network(s) 104, the traffic may pass through a firewall 110, a network security system 112, and/or a router 114 (e.g., edge router). In some examples, the ordering in which traffic is passed through the firewall 110, the network security system 112, and/or the router 114 may be different than what is illustrated in FIG. 1. For example, the network security system 112 may alternatively be topologically located on the trusted network 102 side of the firewall 110 (e.g., between the firewall 110 and the trusted network 102). Additionally, one or more of the firewalls 110, the network security system 112, and/or the router 114 may be omitted from the packet path, in some examples.

In some examples, the firewall 110 may monitor incoming and outgoing traffic of the trusted network 102 and decide whether to allow or block specific traffic based on a defined set of security rules. In this way, the firewall 110 may establish a barrier between any secured and controlled internal networks of the trusted network 102 and the one or more untrusted network(s) 104, such as the Internet, other company networks, or the like. In some instances, the firewall 110 can be a standalone hardware device, software, or both.

In some examples, the network security system 112 may be an intrusion detection system (IDS), an intrusion prevention system (IPS), a combination of both or the like. In some examples, the network security system 112 may continuously monitor incoming/outgoing traffic of the trusted network 102 for malicious activity and, in some examples, take action to prevent malicious activity when it does occur. In some examples, the network security system 112 may detect malicious activity and alert an administrator of the trusted network 102. In various examples, the network security system 112 may filter through a high volume of traffic (e.g., packets) without slowing down network performance.

The architecture 100 also includes a threat detection system 116, which may include components and functionality for performing many of the technologies disclosed herein for cross-domain IoC identification. The threat detection system 116 may include one or more processor(s) 118 and memory 120, which may be communicatively coupled to the one or more processor(s) 118. The memory 120 of the threat detection system 116 may be in the form of non-transitory computer-readable media storing instructions that, when executed by the one or more processor(s) 118, cause the one or more processor(s) 118 to perform the various operations disclosed herein. In some examples, the memory 120 of the threat detection system 116 may store a graph component 122, a threat identification component 124, a threat evaluation component 126, and a report component 128.

In some examples, the threat detection system 116 may receive telemetry data 130 from the network security system 112. The telemetry data 130 may be indicative of interactions between modalities (e.g., user nodes 106 and/or computing resources 108) of the trusted network 102 and entities (e.g., domains) of the untrusted network(s) 104. For instance, the telemetry data 130 may indicate that a user associated with one of the user nodes 106 visited a webpage (e.g., domain) on the internet. As another example, the telemetry data 130 may indicate that an IP address associated with one of the computing resources 108 interacted with a domain via the untrusted network(s) 104.

In some examples, the graph component 122 may include functionality for generating a bipartite graph based at least in part on the telemetry data 130 associated with the network security system 112. In some examples, a bipartite graph determined by the graph component 122 may describe or otherwise be indicative of interactions between one or more entities (e.g., domains) and one or more modalities (e.g., users or IPs). For example, the bipartite graph may include a first set of vertices representing the entities (including both candidate entities and known, malicious entities), a second set of vertices representing the modalities, and multiple edges connecting individual vertices of the first set of vertices with respective vertices of the second set of vertices. In some instances, the multiple edges may represent current or prior interactions between the entities and the modalities.

In some examples, the threat identification component 124 may include functionality for identifying one or more candidate entities (e.g., domains) of the untrusted network(s) that may be malicious. To do this, in some instances, the threat identification component 124 may determine maliciousness scores for the candidate entities based at least in part on the telemetry data 130 or a bipartite graph. In some examples, a value of a maliciousness score for a specific candidate entity may be based at least in part on a number of the user nodes 106 and/or computing resources 108 that are interacting with the specific candidate entity, and which are also interacting with one or more known, malicious entities. For example, the threat identification component 124 may, in some instances, calculate respective maliciousness scores associated with each one of the user nodes 106 and/or computing resources 108 may be determined. In some examples, for each of the respective user nodes 106 and/or computing resources 108, a value of their respective maliciousness score may be equal to a number of known, malicious entities that the respective user node 106 or computing resource 108 is interacting with divided by a total number of the entities that the respective user node 106 or computing resource 108 is interacting with. By way of example, and not limitation, if a first user node 106 is interacting with a total of four entities, and one of the four entities is a known, malicious entity, then the value of the maliciousness score for that first user node 106 may be equal to ¼ (or 0.25). Additionally, in some examples, the maliciousness score associated with the specific candidate entity may be determined by the threat identification component 124 based at least in part on an aggregation of the respective maliciousness scores associated with each one of the modalities that are interacting with the specific candidate entity. Continuing the above example, if the specific candidate entity is interacting with the first user node 106 (maliciousness score value of ¼ (or 0.25) and with a second user node 106 that has a maliciousness score value of ½ (or 0.5), then the maliciousness score value for the specific candidate entity may be equal to the average of ¼ and ½ (which is equal to ⅜ (or 0.375).

In some examples, the threat evaluation component 126 may include functionality for evaluating whether a candidate entity is malicious or not. For example, the threat evaluation component 126 may determine whether a value of a maliciousness score for a specific candidate entity exceeds a threshold value. In some instances, the threshold value may be a specific value set by a threat analyst, such as 0.3, 0.4, 0.6, etc. In some examples, the threat evaluation component 126 may determine a maliciousness rank of a specific candidate entity relative to other candidate entities based at least in part on the value of the maliciousness score, and whether the value of the maliciousness score exceeds the threshold value may be based at least in part on the maliciousness rank of the specific candidate entity. For instance, if the specific candidate entity is within a top ten of candidate entities with a highest maliciousness ranking, then the threshold value may be determined as the maliciousness score value corresponding to the tenth ranked entity.

In some examples, the report component 128 may include functionality for generating a report associated with entities that are likely to be malicious (e.g., entities in which the value of their maliciousness score exceeds the threshold value). In some examples, the report component may provide the report to a threat validating the actual maliciousness of the candidate entities within or outside the trusted network 102. In some examples, a report may include, among other things: (i) a value of a maliciousness score associated with a specific candidate entity: (ii) a request to identify (e.g., classify, label, categorize, etc.) the specific candidate entity as a new malicious entity: (iii) an indication of one or more malicious entities that the user nodes 106 and/or the computing resources 108 have interacted with in addition to the specific candidate entity: (iv) a maliciousness vector associated with the specific candidate entity (which may include respective maliciousness scores associated with each one of the modalities that are interacting with the specific candidate entity): (v) a maliciousness score (e.g., reputation) for each modality (e.g., IPs, files, users, etc.) interacting with the specific candidate entity: (vi) an aggregated score over the maliciousness vector (i.e., over different data sources) for each entity (e.g., domain): (vii) an ordering of both entities and modalities by their maliciousness score; and/or (viii) supporting information providing the reasoning for the maliciousness score, which may contain a subgraph of the bipartite graph indicating the neighbors for each entity or modality node and/or full information for the maliciousness score computation for a given candidate entity.

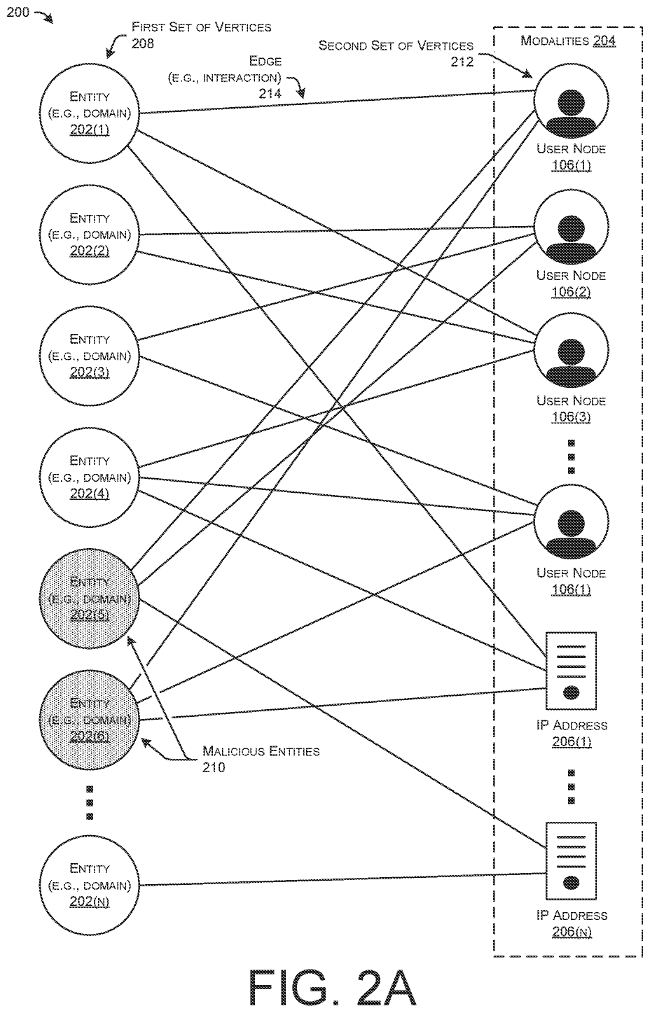

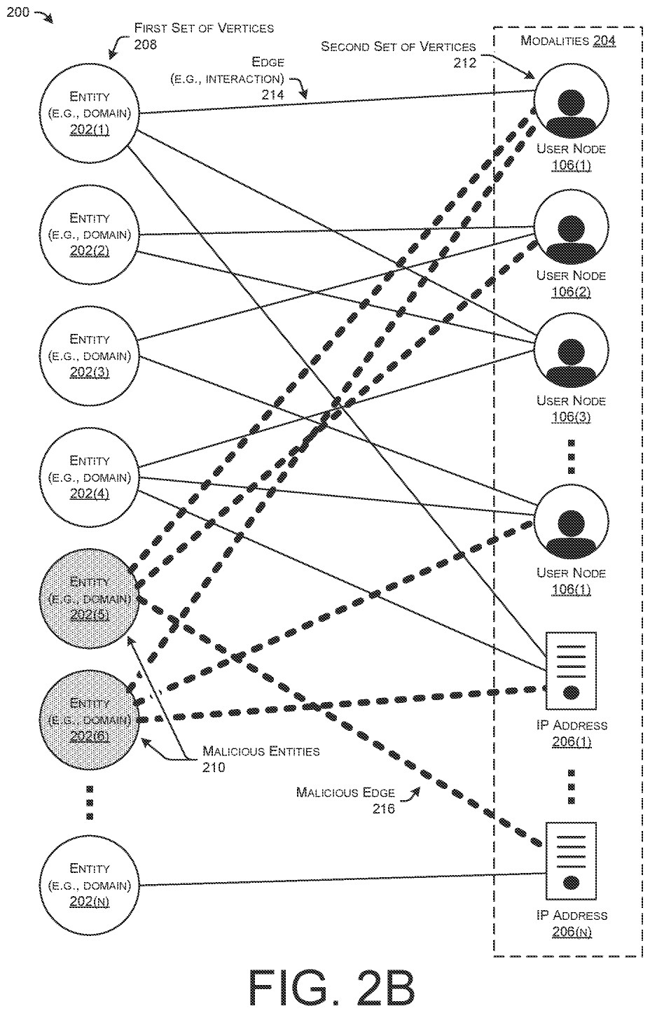

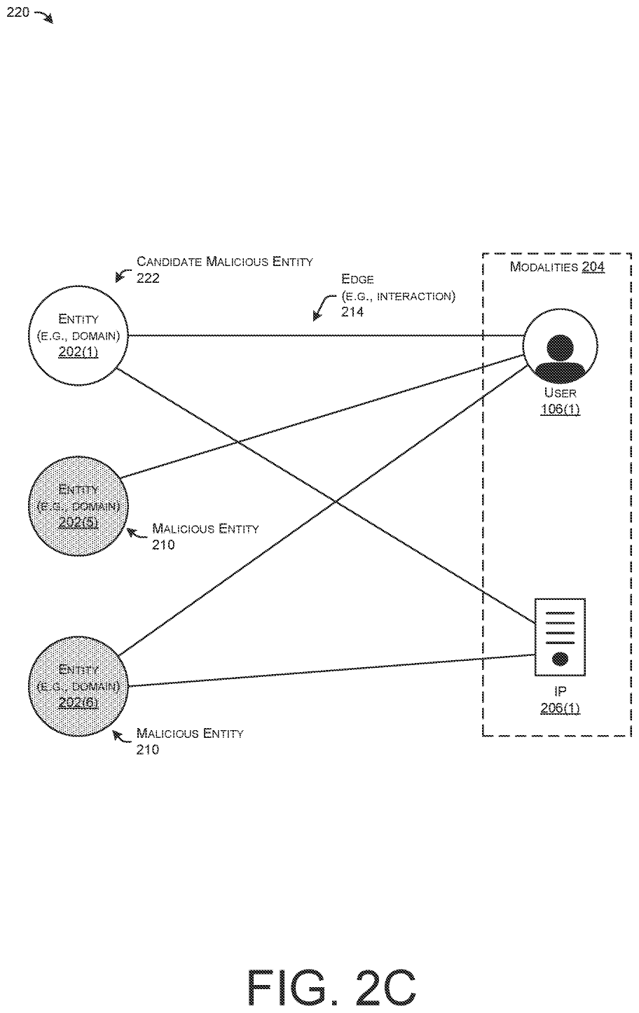

FIG. 2A illustrates an example bipartite graph 200 that may be used as an input for some of the various threat detection techniques and algorithms described herein. For instance, the bipartite graph 200 may be generated by the graph component 122 based at least in part on the telemetry data 130 associated with the network security system 112.

In some examples, the bipartite graph 200 may describe or otherwise be indicative of interactions between one or more entities 202(1)-202(N) (hereinafter referred to collectively as “entities 202”) and one or more modalities 204, which may include one or more user nodes 106(1)-106(N) (hereinafter referred to collectively as “user nodes 106”) and/or one or more IP addresses 206(1)-206(N) (hereinafter referred to collectively as “IP addresses 206”). The IP addresses 206 may correspond with the computing resources 108, in some instances. In FIG. 2A, as well as the other figures herein, “N” may represent any number greater than or equal to one.

In some examples, the bipartite graph 200 may include a first set of vertices 208 representing the entities 202 (e.g., domains). The first set of vertices 208 may, in some cases, include both candidate entities and known, malicious entities 210. Additionally, the bipartite graph 200 may include a second set of vertices 212 representing the modalities 204. The bipartite graph 200 may also include multiple edges 214 connecting individual vertices of the first set of vertices 208 with respective vertices of the second set of vertices 212. In some instances, the edges 214 may represent current or prior interactions between the entities 202 and the modalities 204. For instance, the edge 214 between the entity 202(1) and the user node 106(1) may be indicative that a user associated with the user node 106(1) interacted with the entity 202(1) (e.g., the user visited the domain).

FIG. 2B illustrates the example bipartite graph 200 in which multiple malicious edges 216 have been identified for determining a maliciousness score associated with a modality 204. A malicious edge 216 may be indicative that a modality 204 is interacting with a known, malicious entity 210. In some examples, the threat identification component 124 may determine which edges 214 of the bipartite graph are malicious edges 216.

In some examples, a value of the maliciousness score associated with a modality 204 may be equal to the number of malicious edges 216 connected to a modality 204 vertex, divided by the total number of edges (both normal edges 214 and malicious edges 216) connected to the modality 204 vertex. For example, the maliciousness score value for the user node 106(1) is equal to ⅔ (or 0.66) because the user node 106(1) is connected to two malicious edges 216 and one normal edge 214. Similarly, the maliciousness score values for the other modalities 204 would be as follows: user node 106(2)=⅓ (or 0.33): user node 106(3)= 0/3 (or 0.0): IP address 206(1)=⅓ (or 0.33); and IP address 206(N)=½ (or 0.5).

In some examples, the maliciousness score value associated with an entity 202 may be equal to an aggregation or average of the maliciousness scores associated with all of the modalities 204 to which the entity 202 is connected by an edge 214 and/or malicious edge 216. For instance, the value of the maliciousness score for the entity 202(1) would be equal to an aggregation or average of the maliciousness scores for the user node 106(1), the user node 106(3), and the IP address 206(1). This maliciousness score value for the entity 202(1) may be calculated as follows:

$$\frac{\frac{2}{3} + 0 + \frac{1}{3}}{3} = \frac{1}{3} = 0.33$$

where ⅔ corresponds with the user node 106(1), 0 corresponds with the user node 106(3), and ⅓ corresponds with the IP address 206(1). Similarly, the maliciousness score values for the other entities 202 would be as follows: entity 202 (2)=⅙ (or 0.167): entity 202(3)=⅓ (or 0.33): entity 202(4)= 2/9 (or 0.22); and entity 202(N)=½ (or 0.5). Other aggregations than calculating the mean in this example may be used.

FIG. 2C illustrates an example subgraph 220 of the bipartite graph 200 that indicates respective modalities 204 connecting a candidate malicious entity 222 to a known, malicious entity 224. In the example subgraph 220, the entity 202(1) has been identified as a candidate malicious entity 222 based at least in part on the value of its maliciousness score exceeding a threshold value. The subgraph 220 may include all of the edges 214 connecting the entity 202(1) to modalities 204 that are also connected to malicious entities 210. Although not illustrated, in some examples, the subgraph 220 may further include edges 214 connecting the entity 202(1) to modalities 204 that are not connected to malicious entities 210. In some examples, the subgraph 220 may be included in a report that is sent to a threat analyst associated with the trusted network 102.

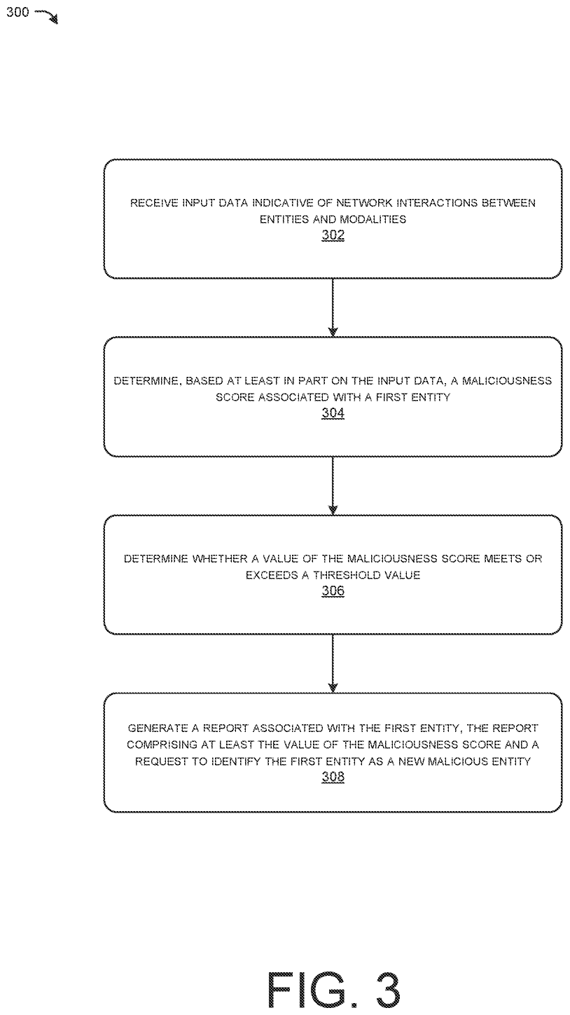

FIG. 3 is a flow diagram illustrating an example method 300 associated with the threat detection techniques described herein. The logical operations described herein with respect to FIG. 3 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 3 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

The method 300 begins at operation 302, which includes receiving input data indicative of network interactions between entities and modalities. For instance, the threat identification component 124 may receive the input data from the graph component 122. In some examples, the input data may be a bipartite graph 200 that is indicative of the interactions between the entities and the modalities. The bipartite graph may be generated or otherwise determined by the graph component 122 based at least in part on telemetry data 130 associated with the network security system 112. In some examples, the bipartite graph may include a first set of vertices representing the entities (including both candidate entities and known, malicious entities), a second set of vertices representing the modalities, and multiple edges connecting individual vertices of the first set of vertices with respective vertices of the second set of vertices. In some instances, the multiple edges may represent current or prior interactions between the entities and the modalities.

At operation 304, the method 300 includes determining, based at least in part on the input data, a maliciousness score associated with a first entity. For instance, the threat identification component 124 may determine the maliciousness score associated with the first entity 202(1). In some examples, the threat identification component 124 may determine maliciousness scores for multiple entities. In some examples, a value of the maliciousness score for the first entity may be based at least in part on a number of the modalities 204 that are interacting with the first entity, and which are also interacting with one or more known, malicious entities 210. In some examples, respective maliciousness scores associated with each one of the modalities 204 may be determined. In such examples, for each of the respective modalities, a value of their respective maliciousness score may be equal to a number of known, malicious entities that the respective modality is interacting with divided by a total number of the entities that the respective modality is interacting with. By way of example, and not limitation, if a first modality is interacting with a total of four entities, and one of the four entities is a known, malicious entity, then the value of the maliciousness score for that first modality may be equal to ¼ (or 0.25). Additionally, in some examples, the maliciousness score associated with the first entity may be determined based at least in part on an aggregation of the respective maliciousness scores associated with each one of the modalities that are interacting with the specific candidate entity. Continuing the above example, if the first entity is interacting with the first modality (maliciousness score value of ¼ (or 0.25) and with a second modality that has a maliciousness score value of ½ (or 0.5), then the maliciousness score value for the specific candidate entity may be equal to the average of ¼ and ½ (which is equal to ⅜ (or 0.375).

At operation 306, the method 300 includes determining whether a value of the maliciousness score meets or exceeds a threshold value. For instance, the threat evaluation component 126 may determine whether the value of the maliciousness score meets or exceeds the threshold value. In some instances, the threshold value may be a specific value set by a threat analyst, such as 0.3, 0.4, 0.6, etc. In some examples a maliciousness rank of the first entity relative to other candidate entities may be determined based at least in part on the value of the maliciousness score. Additionally, whether the value of the maliciousness score exceeds the threshold value may be based at least in part on the maliciousness rank of the first entity. For instance, if the first entity is within a top ten of candidate entities with a highest maliciousness ranking, then the threshold value may be determined as the maliciousness score value corresponding to the tenth ranked entity.

At operation 308, the method 300 includes generating a report associated with the first entity, the report comprising at least the value of the maliciousness score and a request to identify (e.g., classify, label, categorize, etc.) the first entity as a new malicious entity. For instance, the report component 128 may generate the report associated with the first entity 202(1). In some examples, the report associated with the first entity may be generated based at least in part on the value of the maliciousness score meeting or exceeding the threshold value. In some examples, the report may be sent to a threat analyst associated with the trusted network 102. In some examples, the report may include the value of the maliciousness score associated with the first entity and a request to identify (e.g., classify, label, categorize, etc.) the first entity as a new malicious entity. Additionally, or alternatively, the report may include an indication of the one or more malicious entities that the modalities have interacted with in addition to the first entity. Additionally, or alternatively, the report further may include a maliciousness vector associated with the first entity, the maliciousness vector including respective maliciousness scores associated with each one of the modalities that are interacting with the first entity. In addition, or in the alternative, to the examples above, the report may also include one or more of: (i) a maliciousness score (e.g., reputation) for each modality (e.g., IPs, files, users, etc.) interacting with the first entity: (ii) an aggregated score over the maliciousness vector (i.e., over different data sources) for each entity (e.g., domain): (iii) an ordering of both entities and modalities by their maliciousness score; and/or (iv) supporting information providing the reasoning for the maliciousness score, which may contain a subgraph of the bipartite graph indicating the neighbors for each entity or modality node and/or full information for the maliciousness score computation for a given candidate entity.

In both homogeneous and heterogeneous ensemble methods individual models can be referred to as “weak learners” in the homogeneous ensemble method, these weak learners are built using the same machine learning algorithms, whereas in the heterogeneous ensemble methods these weak learners are built using different machine learner algorithms. Weak learning is similar to other machine learning models. However, unlike strong learning models weak learner models will not try to generalize for all possible target cases. The weak learners only try to predict a combination of target cases or a single target accurately. For each model, a sample of data is taken. However, care should be taken in creating these samples of data, because taking data randomly will result in a single sample with only one target class or the target class distribution will not be the same. This will affect model performance.

To overcome this, “bootstrapping” can be used to create samples of data. Bootstrapping is a statistical method to create a sample of data without leaving the properties of the actual dataset. The individual samples of data are called “bootstrap samples”. Each sample is an approximation for the actual data, and all data points in the samples are randomly taken with replacement. These individual samples have to capture the underlying complexity of the actual data. All data points in the samples are randomly taken with replacement.

Weak learners are individual models used to predict the target outcome. However, these models are not the optimal models. They are not generalized to predict accurately for all of the target classes and for all of the expected cases. The weak learner models focus on predicting accurately only for a few specific cases or classes of data. However, the combination of all of the weak learners can build a strong, high-fidelity model. Bagging and boosting can be used to aggregate the signals from the weak learner models to generate a strong, high-fidelity signal.

In machine learning, “boosting” is an ensemble meta-algorithm for primarily reducing bias, and also variance in supervised learner, and a family of machine learning algorithms that convert weak learners into strong ones. As discussed above, a weak learner is defined to be a classifier that is only slightly correlated with the true classification. It can be label examples better than random guessing. In contrast, a strong learner is a classifier that is arbitrarily well-correlated with the true classification.

While boosting is not algorithmically constrained, most boosting algorithms consist of iteratively learning weak classifiers with respect to a distribution and adding them to a final strong classifier. When they are added, they are weighted in a way that is related to the weak learners accuracy. After a weak learner is added, the data weights are readjusted, which is known as “re-weighting”. Misclassified input data gain a higher weight and examples that are classified correctly lose weight. Thus, future weak learners focus more on the examples that previous weak learners misclassified.

There are many boosting algorithms. The original algorithms were not adaptive and could not take full advantage of the weak learner. Adaptive boosting algorithms were then developed that could better aggregate the weak learner data signals. Only algorithms that are provable boosting algorithms in the probably approximately correct learning formulation can accurately be called boosting algorithms. Other algorithms that are similar to boosting algorithms are sometimes called “leveraging algorithms”, although they are also sometimes referred to as boosting algorithms.

The main variation between many boosting algorithms is their method of weighting training data points and hypotheses. AdaBoost is a popular algorithm as it was the first algorithm that could adapt to the weak learners. It is often the basis of introductory coverage of boosting in university machine learning courses. There are many more recent algorithms such as LPBoost, TotalBoost, BrownBoost, xgboost, MadaBoost, LogitBoost, as well as others. Many boosting algorithms fit into the Any Boost framework, which shows that boosting performs gradient descent in a function space using a convex cost function.

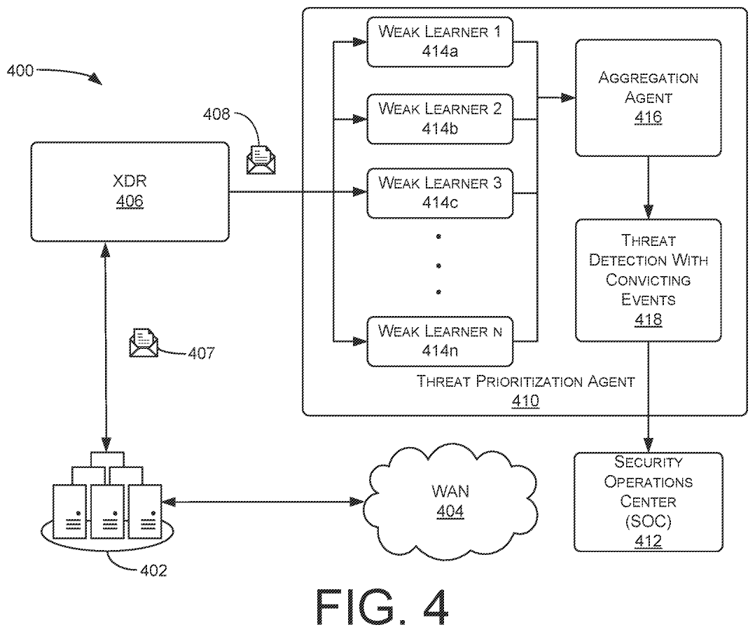

FIG. 4 is a schematic illustration of a computer network architecture 400 employing weak learner models and link aggregation to efficiently identify nodes for malicious threat investigation. The computer network architecture 400 includes a private network that can be an Enterprise Network 402. The Enterprise Network can a business network, government network campus network, data center, etc. The Enterprise network includes a plurality of devices such as computers, mobile device etc. (not shown in FIG. 4) that can in some instances be in communication with an external Wide Area Network (WAN 404) such as the Internet. Since devices (assets) of the Enterprise Network 402 can be in communication with devices of the WAN 404, there is potential for the devices to be infected by malicious threats present on the WAN 404 such as malware, ransomware, etc.

The Enterprise Network 402 is in communication with a security service such as an Extended Detection and Response service (XDR 406). In some embodiments the Enterprise Network 402 can be in communication with the XDR via the WAN 404. The Enterprise Network 402 sends security Event Data 408 related to the Enterprise Network 402 to the XDR 406. The security event data can include network telemetry data as well as other data such as antivirus logs, endpoint logs, etc. The Event Data 408 can include network telemetry data from multiple sources and can include event data from other sources as well. The XDR 406 collects threat data (i.e., Event Data 407) from previously siloed security tools across the Enterprise Network 402 and connected devices in order to provide investigation threat hunting, and response. An XDR platform can collect security event data such as network telemetry data and other data from endpoints, cloud workloads, network email, network nodes, antivirus logs, endpoint logs and more.

The XDR 406 analyzes and processes the collected Event Data 407 to generate information regarding security events 408 which may be enriched with additional useful information. As mentioned above, the security events 408 can be from multiple sources, such as, but not limited to, network data, endpoint device data, antivirus service information, etc.

The XDR 406 sends the security event information 408 to a Threat Prioritization Agent 410. The Threat Prioritization Agent 410 ranks and prioritizes threat scores of various nodes and devices such as computers, routers switches, etc. of the Enterprise network. The Threat Prioritization Agent 410 provides information prioritized threat data as well as event evidence related to the related to the prioritized nodes to a Security Operations Center (SOC 412).

The Threat Prioritization Agent 410 uses a weak learner and aggregation model to efficiently analyze and prioritize threats to provide prioritized data regarding nodes to be investigated to the SOC 412. The Threat Prioritization Agent 410 includes a plurality of weak learner models to analyze the event information 408 received from the XDR 406. The weak learner models can be referred to as Weak Learner1 414a. Weak Learner2 414b, Weak Learner3 414c . . . . Weak LearnerN 414n. Although four such weak learners are shown in FIG. 4, this is by way of example as the Threat Prioritization Agent 410 can include many more such weak learner models. Each weak learner 414a-n analyzes a specific aspect of the event information 408, leaving other aspects to be analyzed by other Weak learners. For example, each of the weak learners 414 can analyze the correlations between events, patterns of events, and many other specific aspects of the received security event information.

The Weak Learners 414 send their collected and analyzed event information to an Aggregation Agent 416. The Aggregation Agent 416 analyzes and aggregates the event information from each of the Weak Learners 414 to generate high fidelity threat information. The Aggregation Agent 416 uses this high-fidelity threat information to generate prioritized threat data as well as convicting event evidence (Threat Detection With Convicting Events 418). In this way, the Aggregation Agent 416 can provide threat information that includes an identity of nodes selected for further investigation as well as convicting evidence data for those nodes. The generated Threat Detection With Convicting Events 418 is sent to the SOC 412 so that the SOC 412 can efficiently focus on the highest risk security threats with events and evidence to allow the SOC 412 to investigate nodes for security threats. As specific examples of possible weak learner models, the Weak Learners 414 could include models for processing: time-based event burst detection: pivot key extraction; and time-key delineated anomaly detection, with a single Weak Learner 414 processing each of the types of data.

The Threat Prioritization Agent 410 provides a threat detection framework that utilizes parameterized events of varying levels of confidence, signal strength, and knowledge from multiple sources such as from multiple telemetries, vendors, endpoints, products, etc. As the fidelity and contents of the events may be unknown, it is necessary to combine them into a strong signal indicating a high probability of the presence of malware. Through the combination of weak learner signal into multiple stronger ones, which are again combined to a final strong decision signal, false positive threat detection rates decrease, allowing for more concentrated response from threat analysts of the SOC 412. Additionally, the extracted event aggregate provided by the Aggregation Agent 416 provides all of the necessary information (grouped under one incident for the specific threat) to a member of the SOC 412 response team and provides the story line starting with the event of the infection vector and continuing with the rest of the execution chain of the malware. This information can then be leveraged in the remediation steps. Furthermore, with the extracted convicting evidence, response time can be decreased, since it is no longer necessary for the SOC 412 team to search through the full event space for the given asset (e.g., device of the Enterprise Network 402). This framework can provide inherently explainable detections to aid threat conviction and remediation.

Security events represent detections created by any product based on analyses of its specific raw telemetry. In an ideal world, the security events would represent indicators of malicious behavior, however, this is not assured in a cross-domain, multi-source setting. Therefore, further processing of security events can be used to improve threat detection. Parameterized security events can consist of 5 elements: type, id, pivot keys and detection source. The “type” is a unique identifier of the event type. For example, an event with a type “AAA” represents that the event comes from a detector that generates an event when the file/shadow/etc. is read, while an event with a type “AAB” comes from a detector that indicates a non-user activity. An “id” is a unique identifier of the individual event. No two distinct events have the same id. A set of attributes (or observables) that are relevant to the detection (not limited to argy, url, file hash, etc.). Pivot keys are a set of keys based on which pivoting makes sense depending on the domain. Examples may include the file_hash, domain, hostname, IP ranges, etc. These keys are well defined by domain experts and may be extracted from the attributes. The “detection source” is the source of the detection. An example could be the telemetry type or the engine generating the events.

In the example discussed above with reference to FIG. 4, the Threat Prioritization Agent 410 processes events from multiple sources. Because their information value is unknown, the solution utilizes the multiple weak learner models (Weak Learners 414). The Weak Learners 414 are models that amplify the signals from the input events. This process takes advantage of having multiple lower fidelity indicators to create a strong base for malware conviction. To do this, the ensemble model uses the Aggregation Agent 416, which combines the knowledge from the indicators from the Weak Learners 414 into a single decision about the presence of malware on a device.

As the output of each weak learner is both a score relating the model's confidence of a threat's presence and a set of events upon which the score is based, it is possible to provide not only a final maliciousness score to the threat analyst, but also convicting evidence (a set of events which indicated the threat).

The input of this step is multiple sets of events identified as interesting by the weak learner models. Utilizing the event unique identifiers (id), it is possible to determine the overlap of the identified events across the models, (i.e., the number of models which identify the same events as important). The higher the overlap, the stronger the case for the event to be interesting to a threat analyst as a part of the convicting evidence. Based on this, it is possible to calculate an overlap score for each event or set of events. The events identified by fewer engines may be relevant to the analyst as being related but not triggering events such as, for example, events which further assist in explaining the threat and the stage of the kill chain at which it has been detected. Using both the weighting information applied to the score of the individual model in the ensemble model as well as the score it is possible to calculate based on overlapping of event it is possible to identify the most important and relevant events in relation to the threat. This will be described in greater detail herein below.

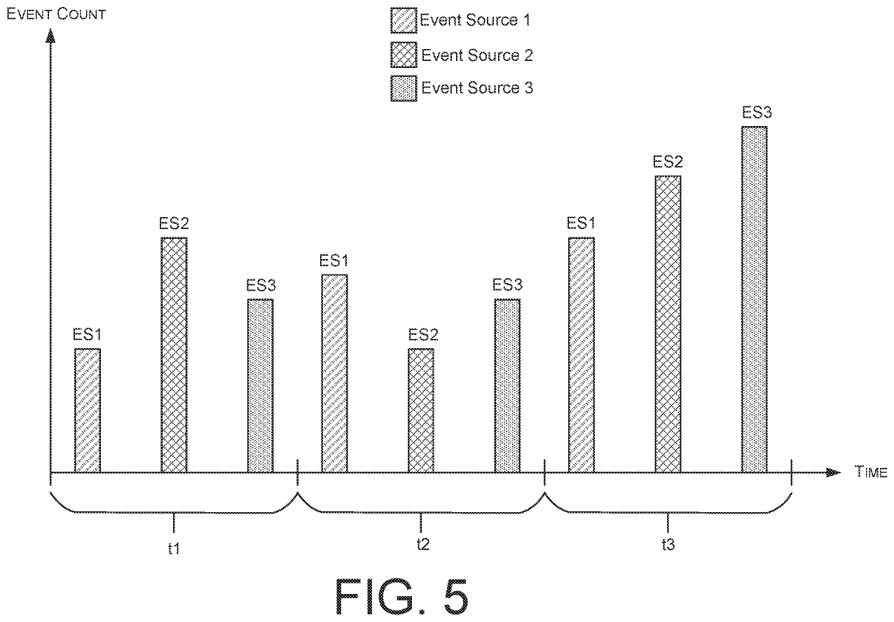

FIG. 5 is a bar graph illustrating the cardinality of events generated by individual sources. Multiple sources of events can be used to identify existing or new malware. Unique event types are distrusted according to some binnable attribute (e.g., time, unique flow identifier). In the graph of FIG. 5, bar represents the observed set of unique event types from a single engine within the burst. A burst is defined as a sudden increase in the number of unique event types compared to the distribution in the previous time-windows. Therefore, it is possible to identify anomalies within the distributions themselves. In order to identify a potential threat, the changes to the distributions across time can be investigated, where peaks in events across multiple sources would indicate a higher likelihood of malware, therefore, marking this instance to be further inspected by an analyst. As peaks and troughs within distributions of such scale are less common, the number of analyst-handled cases can be reduced.

By way of example with reference to FIG. 5, a finite number of events can be analyzed from three weak learner engines. Analyzing their distributions on an asset across predetermined time windows t1, t2, t3, results in the distribution shown in FIG. 5. The event counts for each time window from each event source are shown as ES1, ES2, and ES3. Analyzing the graph, it can be seen that there is peak in event alerts, which is not comprised of a repetition of a single event, but rather includes a high probability of a high cardinality of the analyzed event set. As the distribution of these events through time within the remainder of the data is smooth, this peak can be identified as an increased probability of a threat's presence which requires further investigation.

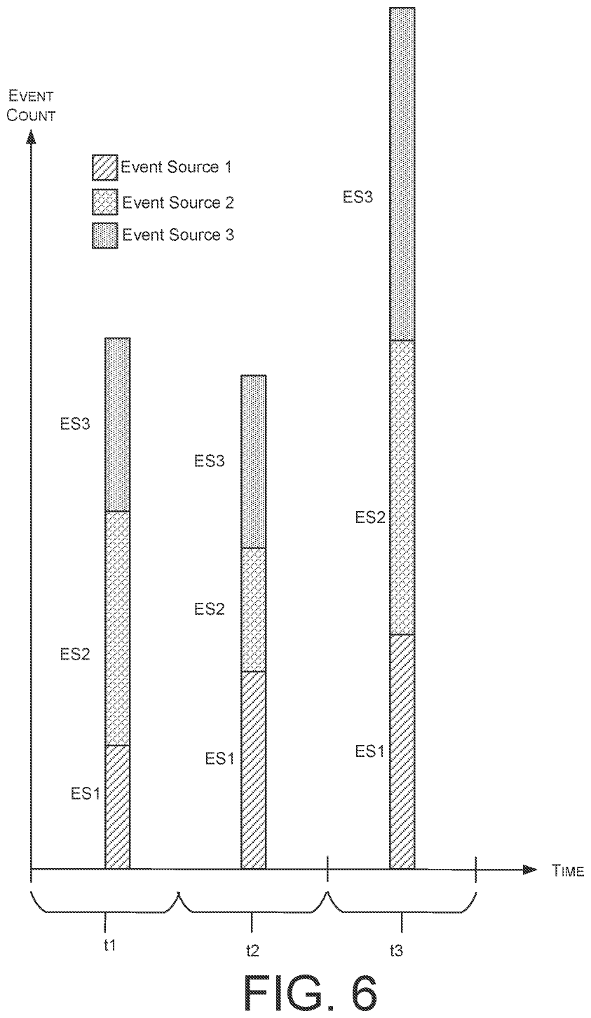

FIG. 6 is a bar graph illustrating combined cardinality of events for multiple time windows. The output of this model is comprised of a score which indicates the confidence of a threat being present on an asset of the Enterprise Network 402 (FIG. 4), based on the burst. Furthermore, it is possible to feed the resulting identified burst (peak in event cardinality) as a set of events to another model (e.g., pivot key extraction). Using the set of events observed on an asset, pivot keys can be extracted, obtaining a set of pivot keys for each event. The set of events utilized in this model may be acquired from any type of binning (e.g., full day time window; burst time window; flow window, etc.).

Due to all of these events being observed during a single time window; there is a risk of attributing all of the events (behaviors) to the same process. There are events which could justify unusual behavior. For example, security software updates are known to occasionally perform malware-like behaviors. Therefore, there is a risk of ignoring the threat by attributing all events to this process, or generating many false positives, when a part of the process which is known to be benign may be mixed in with other unrelated weak signals.

Therefore, by extracting the keys, it is possible to differentiate which events relate to specific processes. The events related to such unusual but benign behavior (such as security software updates) can be grouped together and can be eliminated from the threat detection. This can leave a smaller set of events, which can provide more confidence in not including benign behavior. This ensures that the detection of threats has a higher confidence and fidelity.

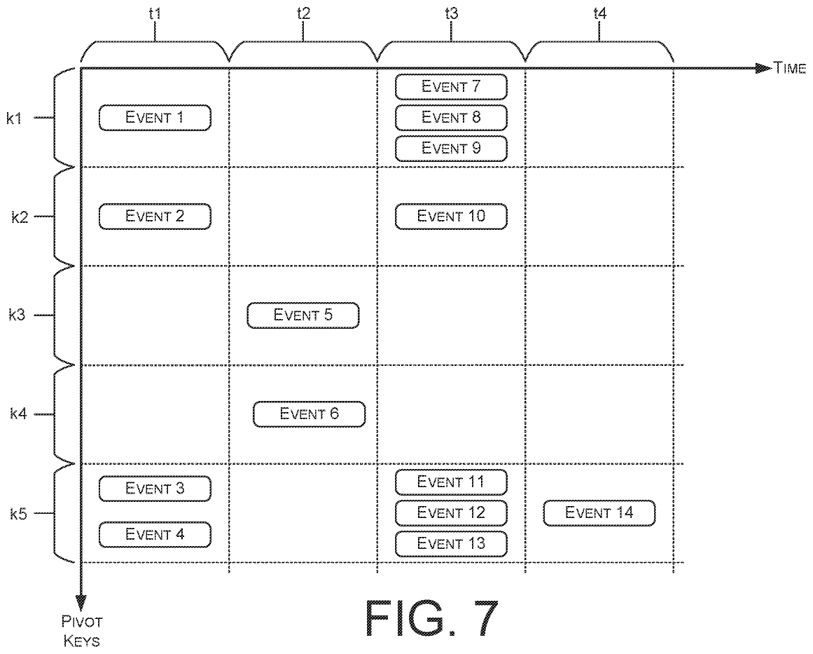

FIG. 7 is a graph illustrating grouped threat events organized by time and pivot keys. Utilizing both time window and pivot key defines a further delineation of event relation as shown in FIG. 7. This enables the model to utilize methods from the previous two models and investigate the proximate events in relation to the pivot key to which the threat's indicated behavior events are related. Therefore, events which indicated weak fidelity and confidence behaviors describing the initial stages of the threat's attack can be identified. For example, in FIG. 7 it can be seen that there is a burst of events in time window t3. It may be the case that the events contain a combination known to indicate a malware threat (e.g., event 7, 8, 9 in relation to pivot key kl. Therefore, by moving backwards in time, it is possible to increase the confidence of the malware detection through the identification of the malware's prior execution chain events. For example, event 1 may show a behavior which illustrates an action earlier in the threats kill chain. Similarly, we can assist in eliminating false positives through this process by confirming the wider behavior pattern of individual processes.

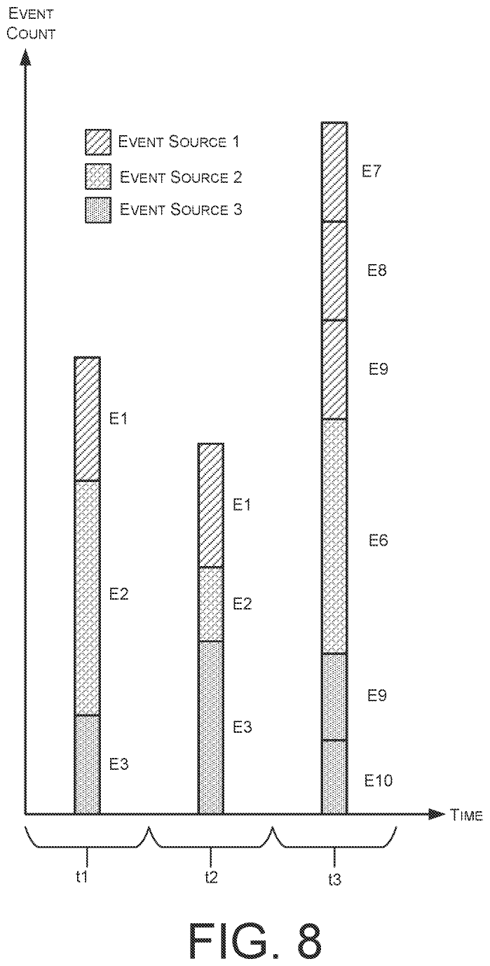

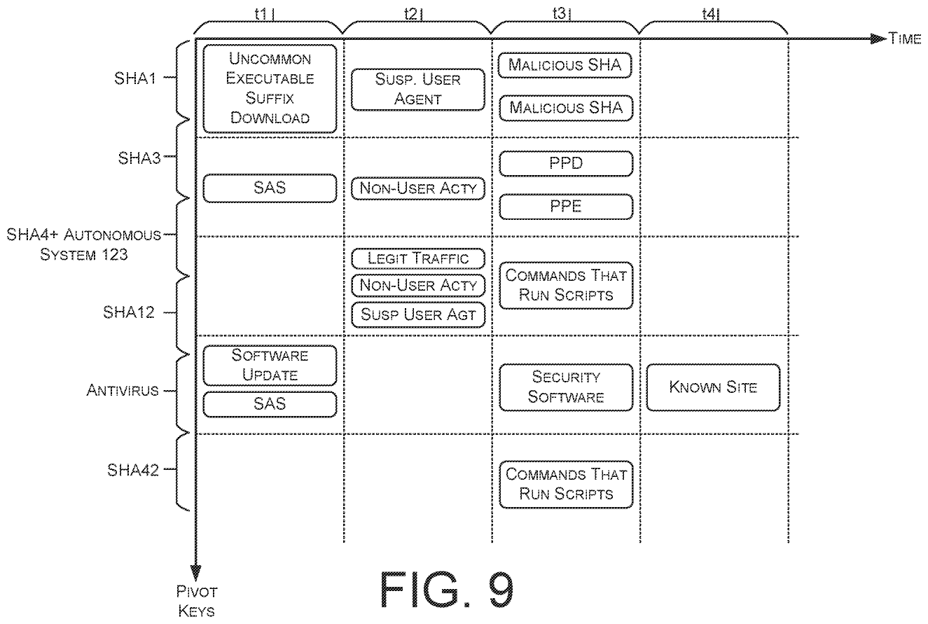

FIG. 8 is a bar graph illustrating combined cardinalities of events in each individual time window. The graph shows additive individual events for each time window. Event sources are identified by different types of cross hatching for each event source. As it was previously described, the first detector in the ensemble is a burst detector. By generating a histogram of detected events that are binned based on a short time window, it is possible to detect an anomalously high number of unique event types in the time window t3. This makes it possible to detect the anomalous set of events in a noisy distribution. In the example shown in FIG. 8, the interesting set of events is: E7, E8, E9, E6, E9, E10. There may be multiple occurrences of each of these events in the burst. Therefore, each of the event bars has a different high which represents the count of events. For example, E6 in t3 has more occurrences compared to E9 in time window t3. The burst it calculated based on the cardinality of the set of event types detected in a given time window: FIG. 9 is a graph illustrating time and key separated events with specific examples of possible, real-world event types.

FIG. 9 is a graph illustrating time and key separated events with specific examples of possible, real-world event types. The specific events illustrated in FIG. 8 are merely examples of possible events and are not intended as an exhaustive list. Many other types of events are possible in a real-world scenario. FIGS. 8 and 9 together can be used to illustrate an analysis of real-world event types. In one embodiment, examples of real-world event types can be formally in a format of E (type, attributes, pivot keys, detection source). Examples of real world events can include: E7 (Powershell payload download, {powershell.exe iex (object.donwloadstring (malware.com)): payloadSHA: autonomous system number=123}: set (SHA3, SHA4, malware.com, autonomous system 123), src3} extracted set (SHA3, SHA4, malware.com, autonomous system 123) E8 (Powershell payload execution, {argv: powershell.exe-: path: file:/C:\Users\redacted\powershell.exe: SHA3: certificate . . . }, set (SHA3), src3} extracted set (SHA3) E9 ([Engine name] detected a malicious SHA, {3rd party engine AAA: SHA1: serial_number: stack_trace . . . }, set (SHA1), src3} extracted set (SHA1) E6 (Commands that run scripts, {argv: cmd.exe/c malware.cmd: cmdSHA: SHA12: scriptSHA: SHA42}, set (SHA12, SHA42), src2) extracted set (SHA12,SHA42) E9 ([Engine name] detected a malicious SHA. {3rd party engine AAA: SHA1}, set (SHA1), src1} (This event is repeated in the given time-window multiple times: omitted for simplicity) extracted set (SHA1) E10 Security software, {ipv4-1.2.3.4: hostname=anitivirus.com: autonomous system name=example: country: . . . }, set (antivirus.com, autonomous system example, country), src1) extracted set (antivirus.com, autonomous system example, country).

Using the extracted pivot keys, it is possible to both eliminate events which are not relevant to the process which caused the event burst within the time-window; and further separate the processes happening simultaneously. In this case, it can be seen that the event indicating security software is not related through any pivot key to other anomaly-indicating events. This is useful to know, as security software is known to, at times, initiate anomalous behavior particularly during updates. As it is not related on the basis of any pivot key to the remainder of the anomalous behavior indicating events, it can be confidently eliminated from consideration. Similarly, it can be observed that multiple anomalous events are related to the same pivot key, which further increases the confidence of legitimate threat presence.

Further analyzing the examples of the asset indicative of the malware dropper (Metamorfo), it can be determined that the events of interest relate to the pivot key SHA1, SHA3. SHA4, SHA12 and SHA42 within the time window t3. Therefore, by moving backwards in time can increase confidence of the malware detection through the identification of the malware's prior execution chain events. In this example, it can be seen that the event of uncommon executable suffix download related to SHA3, suspicious autonomous systems and suspicious user agent (SHA4), and non-user activity (SHA12). These are consistent behaviors with the with the malware dropper threat behaviors earlier in the kill chain.

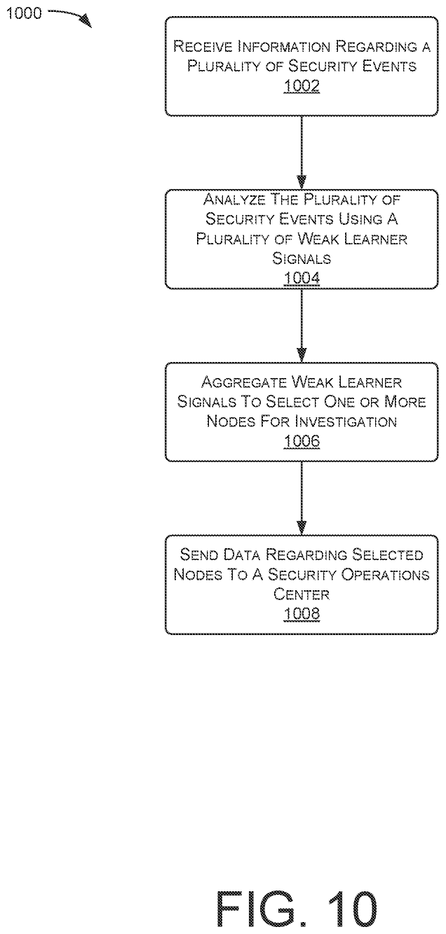

FIG. 10 is a graph illustrating a method 1000 for prioritizing cyberthreats using a weak learner and aggregation model. Security event data information regarding a computer network is received 1002. The event information includes a plurality of events which can derive from multiple telemetries, endpoint devices software updates, as well as many other sources. In one embodiment, the security event information can be received from an Extended Data and Response (XDR) service.

The plurality of events are analyzed using a plurality of weak learner models 1004. The plurality of weak learner models can be models that are each configured to analyze a particular aspect of the security event information. A plurality of weak learner signals are received from the plurality of weak learner models. The plurality of weak learner signals are aggregated to select one or more nodes for investigation 1006. The aggregation of the plurality of weak leaner data signals can produce a high-fidelity data signal with a high confidence of selecting nodes for investigation. Data regarding the one or more selected nodes is sent to a Security Operation Center (SOC) for further investigation 1008. In one embodiment, along with the data regarding the selected nodes, convicting data regarding those nodes can be sent to the SOC to facilitate the investigation of the selected nodes.

In the domain of cybersecurity, extended detection and response systems (XDR) process security events collected from multiple sources originating from different telemetries, cybersecurity products, vendors, etc. Consequently, the increasing number of security events renders it unfeasible for a Security Operations Center (SOC) team to process and validate all of them. Moreover, the severity of the events might not be known precisely in all cases since different vendors of the integrated security products have different methods of assigning its value. With many examples of security events describing common benign behaviors, such as software updates, or status logs, instead of representing a strong signal indicating the presence of malware, this introduces even more manual work for the SOC team as they need to find the relevant security events manually. On top of that, the SOC team has to find all pieces of evidence for a specific threat so that they know the infection vector and the whole execution chain of the malware that was executed on the device so that they can react to it and remediate the threat.

Techniques described herein address the challenge of retrieval of entities with a particular, typically rare property from a high-volume dataset containing relations between entities. Examination of the properties is not a trivial task, such as calling an external service (SOC) for additional information. Given a limited budget for property examination and a few entities with the desired property (seeds), a goal is to retrieve as many entities of interest as possible.

A particular use-case in implementation is the retrieval of malicious Fully Qualified Domain Names (FQDNs) (with negative reputation) from network security event data. Reputation is computed by an external service Virus Total with limited API quota. Given the customer telemetry, budget of Virus Total API calls, and some initial malicious FQDNs (seeds), the goal is to retrieve as many FQDNs with negative reputation as possible.

The main motivation behind the algorithm is the fact that the intersection of FQDNs from external feeds and customer telemetry is minimal. By processing relational data from customer security event data directly, the output of the algorithm is much more relevant for the end customer compared with the external feeds.

The current cross product paradigm applied in the Extended Detection and Response systems (XDR) aims to aggregate data and detections from various previously unconnected products in order to build the enhanced detection capabilities. The assumption is that it is possible to efficiently reduce noise based on the sheer amount of various data sources. Despite that, the final efficacy of the XDR solution is highly influenced by the efficacy of the underlying products. In many cases, the efficacy of those engines is limited by the missing context: asset tracking is problematic in network-based products due to IP address rotation: missing network trends limit the anomaly detection in endpoint-based products; and missing information about vulnerabilities tends to create noisy detections. In view of this, the standard paradigm of forward feeding XDR systems has efficacy boundaries defined by the quality of the underlying products.

In the world of cross-product threat detection, a well specified domain model plays a crucial role. Existing data models, such as STIX or CTIM, are well suited for the investigation of a created detection by a cyber security analyst. In contrast, limited numbers of layers of detection limits the possibility of automated post-processing as well as precise integration of individual engines. Moreover, integration capabilities are enabled by freedom in objects attributes and their relations. This allows a wider applicability of the domain model, but on the other hand, does not enforce basic cross-product object classification and normalization. Furthermore, the existing data models do not specify the responsibility or read individual layers.

All of this leads to domain objects that are highly specific to each product. Without an explicit separation of layers, multiple products contribute to each of them, which leads to inconsistent and uncorrelated detections being aggregated together to be presented to the cyber security analyst. Cross-product solutions behave as a group of separately acting products, which is in direct contrast with the vision of a unified, cross-product solution. In addition, existing domain models are not designed with a focus on the reduction of the overwhelming number of detections, which cannot be effectively processed by responsible SOC teams. This challenge is even greater in cross-domain systems whose usability and scalability is dependent upon effective reduction and prioritization of detections.

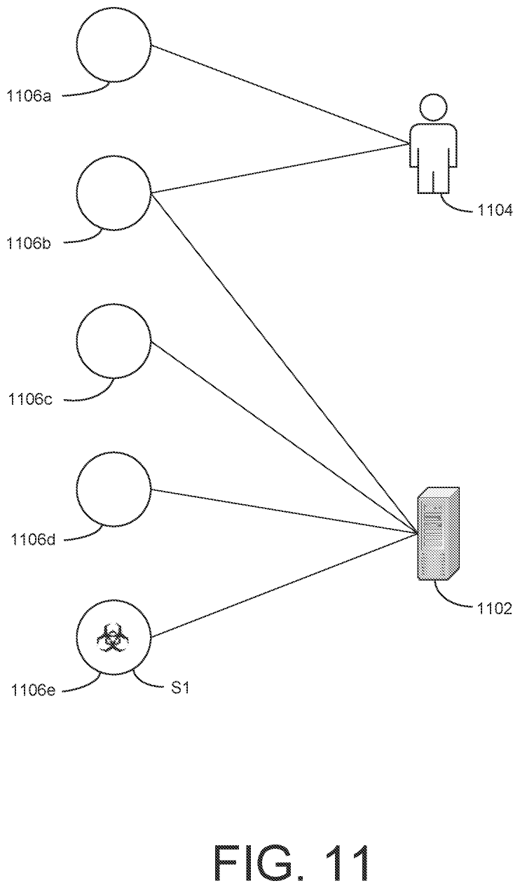

FIGS. 11-13 illustrate an adaptive approach for generating weighting factors for nodes using network telemetry data to construct an Adaptive Risk Map Graph (A-RMG). FIG. 11 shows a connection tree of a Network Device 1102 and a user device 1104 with various nodes 1106(a-e). In FIG. 11, node 1106(e) is a known malicious node. In this first iteration, nodes 1106(e) becomes a seed node for analyzing risk scores for threat prioritization of the remaining nodes. At this iteration, it is unknown whether nodes 1106(a-d) are benign or malicious.

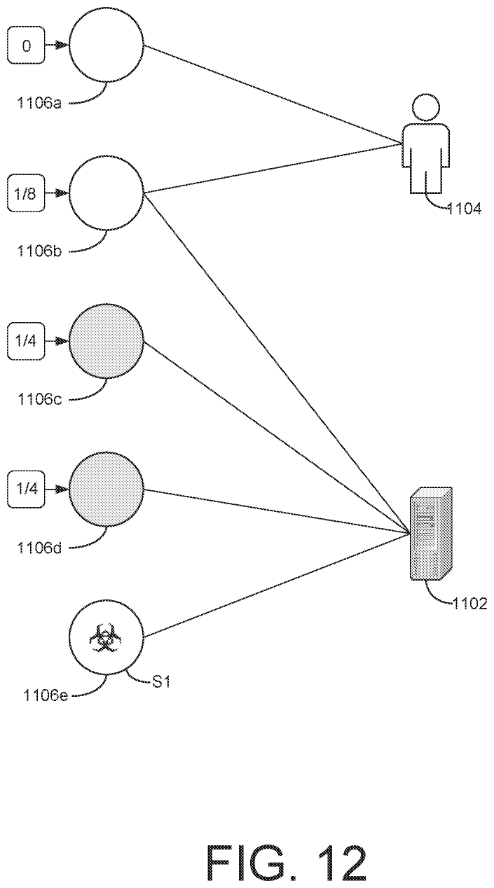

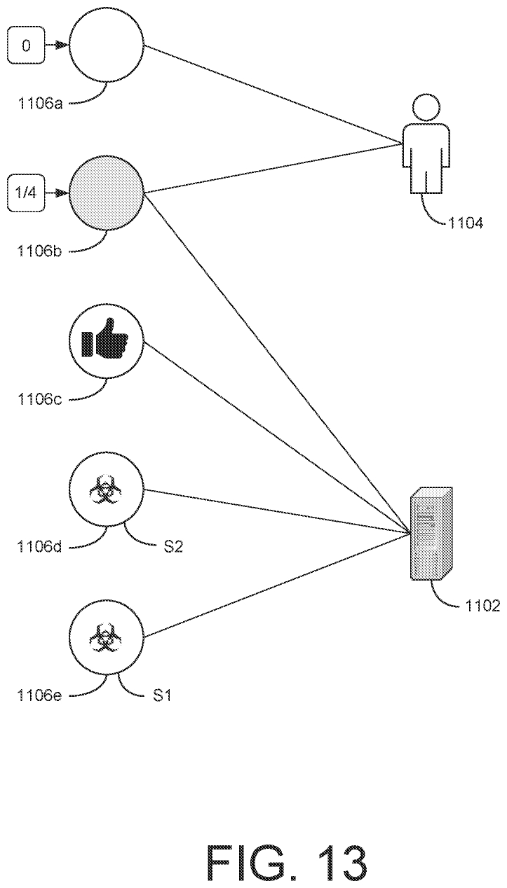

With reference now to FIG. 12, a threat score is assigned to each of the unknown nodes 1106(a-d) based on their connection with the known malicious node 1106(e) (e.g., seed node). A bipartite graph is constructed using techniques such as those described above with reference to FIGS. 2A-2C. Using the previously described scoring algorithm based on telemetry data results in nodes 106(c) and 106(d) having a score of ¼, whereas node 106(b) has a lower score of ⅛ and node 106(a) has a score of 0. Therefore, nodes 106(c) and 106(d) having the highest score are selected for investigation by a Security Operations Center (SOC). By way of example, the SOC analyzes nodes 106(c) and 106(d) and determines that node 106(d) is malicious while node 106(c) is benign. This is shown in FIG. 13. At this point, node 1106 becomes a second seed (S2) for a second iteration of the scoring algorithm. Node 1106(c) is a known benign node and can be removed from the calculation.

Another scoring is performed for a second iteration using the scoring algorithm with the updated seed. Because Node 1106(b) has a higher threat score (¼) than node 1106(a), node 1106(b) is selected for investigation by the SOC, whereby a determination can be made as to whether node 1106(b) is malicious or benign. This iterative process can be performed until either the SOC investigation budget has been reached or all possible nodes have been determined to be either malicious or benign.

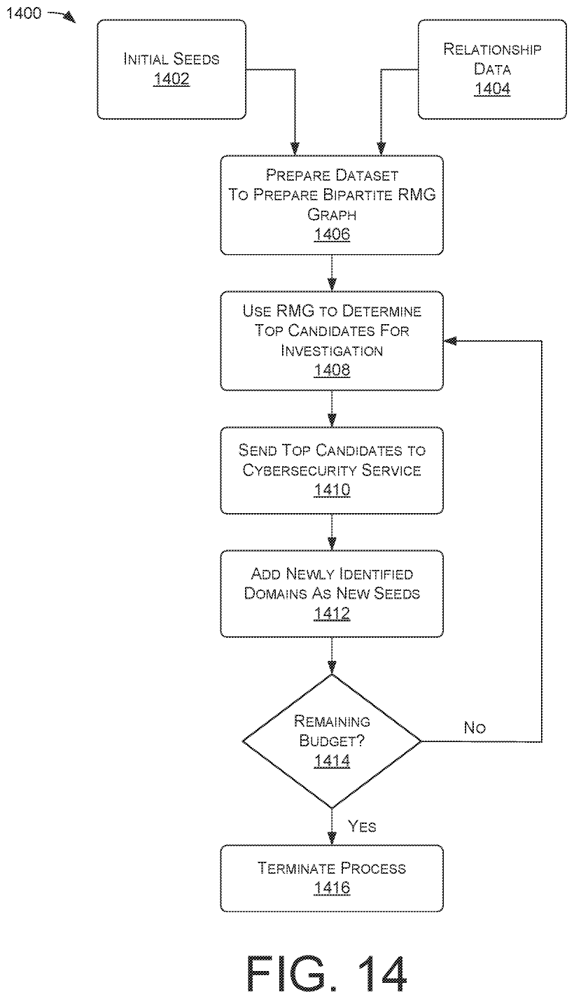

FIG. 14 is a graph illustrating an iterative process 1400 for prioritizing nodes of a network for efficient investigation by an SOC. Initial seed nodes are determined 1402 and relationship data is determined 1404. The initial seeds are nodes that have already been determined, such as by an SOC investigation. The relationship data includes telemetry data and includes relationships and connections between and among devices and nodes of a network such as an enterprise network to be examined.

The initial seed data and relationship data are combined into a dataset to prepare a bipartite Risk Map Graph (RMG) 1406. The bipartite RMG graph is used to determine top candidates for investigation 1408. The determined top candidates are sent to a cybersecurity service 1410. The cybersecurity service can be an SOC as previously described. The security service (e.g., SOC) investigates the top candidates to determine which of the top candidate nodes are actually benign. The benign nodes are then added as newly identified seeds 1412.

In a decision step 1414, a determination is made as to whether the remaining SOC budget has been reached. If the SOC budget has been reached, then the process can be terminated 1416. On the other hand, if the SOC budget has not been reached, then the process returns to Use RMG to determine top candidates for Investigation 1408, adding the newly discovered seed nodes to use RMG to determine new top candidates for analysis. In this way, the process provides an adaptive, iterative technique for adding new seeds to continually determine new top candidates for investigation until either all nodes of interest have been investigated or the SOC budget has been reached.

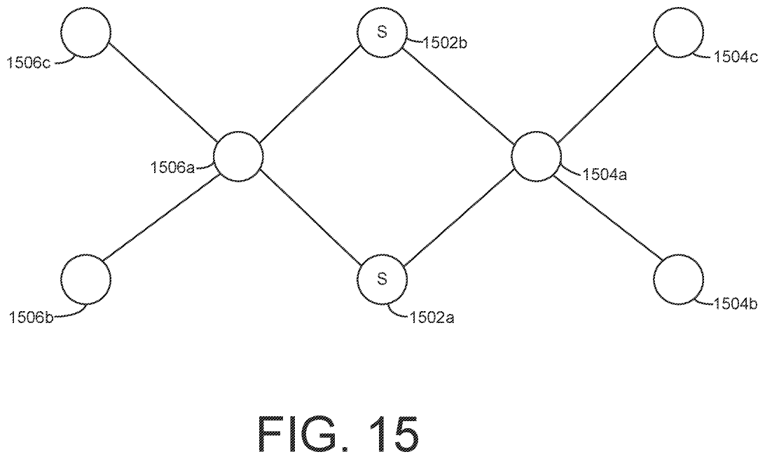

FIGS. 15-17 illustrate advantages of the adaptive approach (A-RMG) over a non-adaptive approach. FIG. 15 shows an interconnection of nodes. In the center are seed nodes 1502a, 1502b. As discussed above, the seed nodes 1502a, 1502b are known malicious nodes. To the right of the seed nodes 1502a, 1502b are nodes 1504a, 1504b, 1504c. To the left of the seed nodes 1502a, 1502b are nodes 1506a, 1506b, 1506c. At this point, it is unknown which if any of the nodes 1504, 1506 are malicious and which are benign.

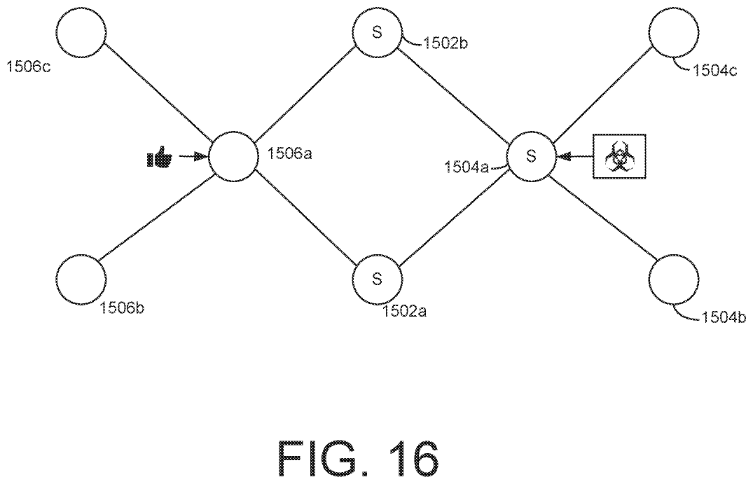

Using the A-RMG analysis, the nodes 1504a. 1504b, which are most directly connected with the seed nodes 1502a. 1502b are selected for investigation by an SOC. After investigation by the SOC, it is determined that node 1504a is malicious, whereas node 1506a is benign. Therefore, using the iterative A-RMG process described above, node 1504a becomes a new seed node, and node 1504a is recognized as a safe, benign node as shown in FIG. 16. The A-RMG can be performed again with node 1504A as the new seed. Using the A-RMG algorithm, nodes 1504b and 1504c will be selected for investigation by an SOC, since they are directly connected with the malicious seed node 1504a. Nodes 1506b and 1506c will not be selected since they are directly connected to safe, benign node 1506a. In this way, the use of A-RMG makes an intelligent selection of nodes for investigation more efficient, reducing unnecessary investigation resources.

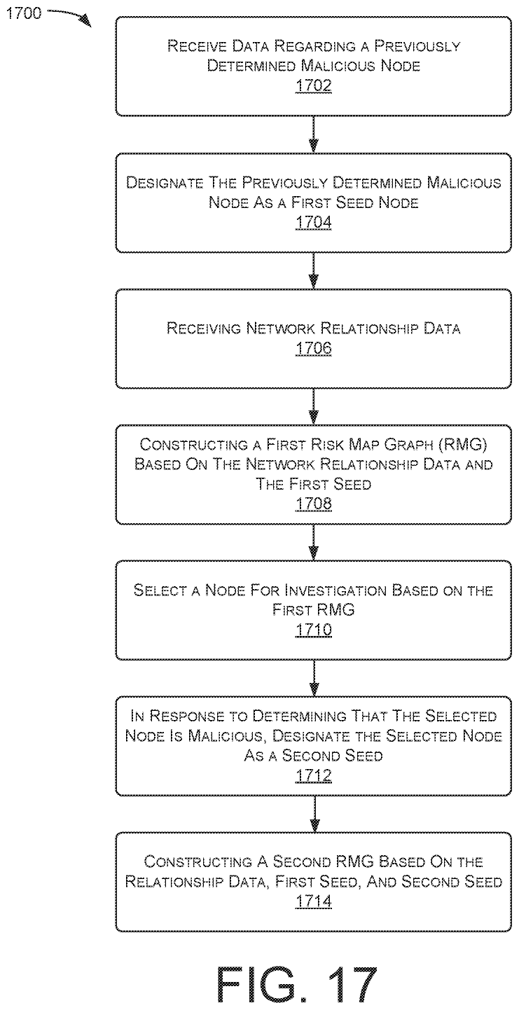

FIG. 17 is a flowchart illustrating a method 1700 for performing an event-based Adaptive Risk Map Graph (A-RMG) analysis of a computer network. Data regarding a previously determined malicious node is received 1702. The previously determined malicious seed is designated as a first seed node 1704. Network relationship data is received 1706. A first Risk Map Graph (RMG) is constructed using the relationship data and the first seed 1708. Based on the first RMG, a node is selected for investigation 1710. The selected node is a node that has been determined to have a high risk of being malicious compared to other nodes based on its relationship to the seed node. In response to determining that the selected node is in fact malicious, the selected node is designated as a second seed 1712. A second RMG is constructed based on the relationship data, the first seed, and the second seed 1714. This process can be repeated iteratively until either the security budged has been met or all relevant nodes have been investigated. In one embodiment, the investigation can be performed by an outside security service such as a Security Operations Center (SOC).

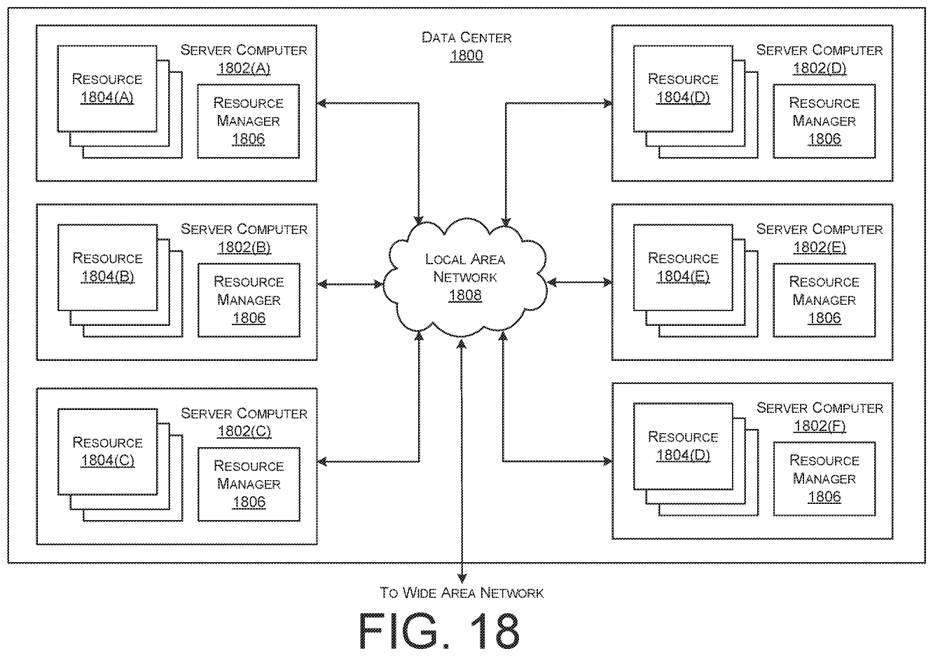

FIG. 18 is a computing system diagram illustrating an example configuration of a data center 1800 that can be utilized to implement aspects of the technologies disclosed herein. The example data center 1800 shown in FIG. 18 includes several server computers 1802A-1802F (which might be referred to herein singularly as “a server computer 1802” or in the plural as “the server computers 1802”) for providing computing resources. In some examples, the resources and/or server computers 1802 may include, or correspond to, any type of networked device or node described herein. Although described as servers, the server computers 1802 may comprise any type of networked device, such as servers, switches, routers, hubs, bridges, gateways, modems, repeaters, access points, etc.

The server computers 1802 can be standard tower, rack-mount, or blade server computers configured appropriately for providing computing resources. In some examples, the server computers 1802 may provide computing resources 1804 including data processing resources such as VM instances or hardware computing systems, database clusters, computing clusters, storage clusters, data storage resources, database resources, networking resources, security, packet inspection, and others. Some of the servers 1802 can also be configured to execute a resource manager 1806 capable of instantiating and/or managing the computing resources. In the case of VM instances, for example, the resource manager 1806 can be a hypervisor or another type of program configured to enable the execution of multiple VM instances on a single server computer 1802. Server computers 1802 in the data center 1800 can also be configured to provide network services and other types of services.

In the example data center 1800 shown in FIG. 18, an appropriate local area network (LAN) 1808 is also utilized to interconnect the server computers 1802A-1802F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 1800, between each of the server computers 1802A-1802F in each data center 1800, and, potentially, between computing resources in each of the server computers 1802. It should be appreciated that the configuration of the data center 1800 described with reference to FIG. 18 is merely illustrative and that other implementations can be utilized.

In some examples, the server computers 1802 may each execute one or more application containers and/or virtual machines to perform techniques described herein. In some instances, the data center 1800 may provide computing resources, like application containers, VM instances, and storage, on a permanent or an as-needed basis. Among other types of functionality, the computing resources provided by a cloud computing network may be utilized to implement the various services and techniques described above. The computing resources 1804 provided by the cloud computing network can include various types of computing resources, such as data processing resources like application containers and VM instances, data storage resources, networking resources, data communication resources, network services, and the like.

Each type of computing resource 1804 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 1804 not mentioned specifically herein.

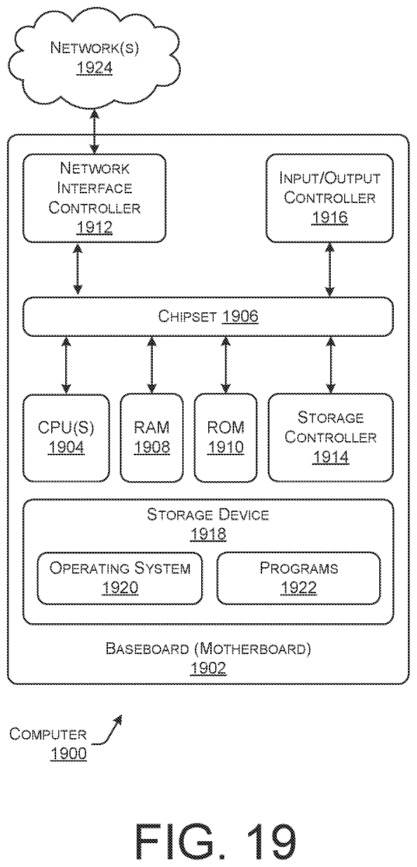

The computing resources 1804 provided by a cloud computing network may be enabled in one embodiment by one or more data centers 1800 (which might be referred to herein singularly as “a data center 1800” or in the plural as “the data centers 1800”). The data centers 1800 are facilities utilized to house and operate computer systems and associated components. The data centers 1800 typically include redundant and backup power, communications, cooling, and security systems. The data centers 1800 can also be located in geographically disparate locations. One illustrative embodiment for a data center 1800 that can be utilized to implement the technologies disclosed herein will be described below with regard to FIG. 19.

FIG. 19 is a computer architecture diagram showing an illustrative computer hardware architecture for implementing a computing device that can be utilized to implement aspects of the various technologies presented herein. The computer architecture shown in FIG. 19 illustrates a conventional server computer, network node, router, workstation, desktop computer, laptop, tablet, network appliance, e-reader, smartphone, load balancer, or other computing device, and can be utilized to execute any of the software components presented herein.

The computer 1900 includes a baseboard 1902, or “motherboard,” which is a printed circuit board to which a multitude of components or devices can be connected by way of a system bus or other electrical communication paths. In one illustrative configuration, one or more central processing units (“CPUs”) 1904 operate in conjunction with a chipset 1906. The CPUs 1904 can be standard programmable processors that perform arithmetic and logical operations necessary for the operation of the computer 1900.

The CPUs 1904 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1906 provides an interface between the CPUs 1904 and the remainder of the components and devices on the baseboard 1902. The chipset 1906 can provide an interface to a RAM 1908, used as the main memory in the computer 1900. The chipset 1906 can further provide an interface to a computer-readable storage medium such as a read-only memory (“ROM”) 1910 or non-volatile RAM (“NVRAM”) for storing basic routines that help to startup the computer 1900 and to transfer information between the various components and devices. The ROM 1910 or NVRAM can also store other software components necessary for the operation of the computer 1900 in accordance with the configurations described herein.

The computer 1900 can operate in a networked environment using logical connections to remote computing devices and computer systems through a network, such as the network(s) 1924. The chipset 1906 can include functionality for providing network connectivity through a NIC 1912, such as a gigabit Ethernet adapter. The NIC 1912 is capable of connecting the computer 1900 to other computing devices over the network(s) 1924. It should be appreciated that multiple NICs 1912 can be present in the computer 1900, connecting the computer to other types of networks and remote computer systems. In some examples, the NIC 1912 may be configured to perform at least some of the techniques described herein.

The computer 1900 can be connected to a storage device 1918 that provides non-volatile storage for the computer. The storage device 1918 can store an operating system 1920, programs 1922, and data, which have been described in greater detail herein. The storage device 1918 can be connected to the computer 1900 through a storage controller 1914 connected to the chipset 1906. The storage device 1918 can consist of one or more physical storage units. The storage controller 1914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1900 can store data on the storage device 1918 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1918 is characterized as primary or secondary storage, and the like.

For example, the computer 1900 can store information to the storage device 1918 by issuing instructions through the storage controller 1914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1900 can further read information from the storage device 1918 by detecting the physical states or characteristics of one or more particular locations within the physical storage units.

In addition to the mass storage device 1918 described above, the computer 1900 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 1900. In some examples, the operations performed by the architecture 400 (FIG. 4) and or any components included therein, may be supported by one or more devices similar to computer 1900. Stated otherwise, some or all of the operations performed by the architecture 400, and or any components included therein, may be performed by one or more computer devices 1900 operating in a scalable arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 1918 can store an operating system 520 utilized to control the operation of the computer 500. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 1918 can store other system or application programs and data utilized by the computer 1900.

In one embodiment, the storage device 1918 or other computer-readable storage media is encoded with computer-executable instructions which, when loaded into the computer 1900, transform the computer from a general-purpose computing system into a special-purpose computer capable of implementing the embodiments described herein. These computer-executable instructions transform the computer 1900 by specifying how the CPUs 1904 transition between states, as described above. According to one embodiment, the computer 1900 has access to computer-readable storage media storing computer-executable instructions which, when executed by the computer 1900, perform the various processes and functionality described above with regard to FIGS. 1-17, and herein. The computer 1900 can also include computer-readable storage media having instructions stored thereupon for performing any of the other computer-implemented operations described herein.

The computer 1900 can also include one or more input/output controllers 1916 for receiving and processing input from a number of input devices, such as a keyboard, a mouse, a touchpad, a touch screen, an electronic stylus, or other type of input device. Similarly, an input/output controller 1916 can provide output to a display, such as a computer monitor, a flat-panel display, a digital projector, a printer, or other type of output device. It will be appreciated that the computer 1900 might not include all of the components shown in FIG. 19, can include other components that are not explicitly shown in FIG. 19, or might utilize an architecture completely different than that shown in FIG. 19.

The computer 1900 may include one or more hardware processors (processors) configured to execute one or more stored instructions. The processor(s) may comprise one or more cores. Further, the computer 1900 may include one or more network interfaces configured to provide communications between the computer 1900 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 1922 may comprise any type of programs or processes to perform the techniques described in this disclosure for identifying malicious actors across datasets of different origin, including convicting malicious network traffic and identifying command-and-control infrastructure associated with newly detected malware even if no direct communication between binaries and domains is observed.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for event-based threat detection in a computer network, the method comprising:
receiving information regarding a plurality of events for a network including a plurality of nodes;
analyzing the plurality of events using a plurality of weak learner models each configured to analyze a particular aspect of the event information to generate a plurality of weak learner data signals; and
aggregating the weak learner data signals to select one or more nodes for investigation.

2. The method as in claim 1, further comprising sending data regarding the selected one or more nodes to a security operations center for investigation.

3. The method as in claim 2, wherein the data regarding the selected one or more nodes includes an identity of nodes selected for investigation and convicting evidence data.

4. The method as in claim 3, wherein the weak plurality of weak learner models include a weak learner model for time-based event burst detection, a weak learner model for pivot key extraction, and a weak learner for time-key delineation.

5. The method as in claim 1, wherein aggregating weak learner signals includes combining events from multiple event sources within predetermined time windows.

6. The method as in claim 5, wherein aggregating weak learner signals includes extracting pivot keys to obtain a set of pivot keys for multiple events.

7. The method as in claim 1, wherein aggregating the weak learner data signals includes using time window and using time window and pivot keys to define event relations.

8. A system for event-based threat detection, comprising:
one or more processors; and
one or more non-transitory computer-readable media storing computer-executable instructions that, when executed by the one or more processors, cause the one or more processors to perform operations comprising:
receiving information regarding a plurality of events for a network including a plurality of nodes:
analyzing the plurality of events using a plurality of weak learner models each configured to analyze a particular aspect of the event information to generate a plurality of weak learner data signals; and
aggregating the weak learner data signals to select one or more nodes for investigation.

9. The system for event-based threat detection as in claim 8, the operations further comprising sending data regarding the selected one or more nodes to a security operations center for investigation.

10. The system for event-based threat detection as in claim 9, wherein the data regarding the selected one or more nodes includes an identity of nodes selected for investigation and convicting evidence data.

11. The system for event-based threat detection as in claim 8, wherein the plurality of weak learner models includes a weak learner model for time-based event burst detection, a weak learner model for pivot key extraction, and a weak learner for time-key delineation.

12. The system for event-based threat detection as in claim 8, wherein aggregating weak learner data signals includes combining events from multiple event sources within predetermined time windows.

13. The system for event-based threat detection as in claim 8, wherein aggregating the weak learner data signals includes extracting pivot keys to obtain a set of pivot keys for multiple events.

14. The system for event-based threat detection as in claim 8, wherein aggregating the weak learner signals includes using time window and using time window and pivot keys to define event relations.

15. One or more non-transitory computer-readable media storing computer-executable instructions that, when executed by one or more processors, cause the one or more processors to perform operations comprising:
receiving information regarding a plurality of events for a network including a plurality of nodes:
analyzing the plurality of events using a plurality of weak learner models each configured to analyze a particular aspect of the event information to generate a plurality of weak learner data signals; and
aggregating the weak learner data signals to select one or more nodes for investigation.

16. The one or more non-transitory computer-readable media as in claim 15, the operations further comprising sending data regarding the selected one or more nodes to a security operations center for investigation.

17. The one or more non-transitory computer-readable media as in claim 16, wherein the data regarding the selected one or more nodes includes an identity of nodes selected for investigation and convicting evidence data.

18. The one or more non-transitory computer-readable media as in claim 15, wherein the weak plurality of weak learner models include a weak learner model for time-based event burst detection, a weak learner model for pivot key extraction, and a weak learner for time-key delineation.

19. The one or more non-transitory computer-readable media as in claim 15, wherein aggregating the weak learner data signals includes combining events from multiple event sources within predetermined time windows.

20. The one or more non-transitory computer-readable media as in claim 15, wherein aggregating the weak learner data signals includes extracting pivot keys to obtain a set of pivot keys for multiple events.
